(19) United States
(12) Patent Application Publication
(10) Pub. No.: US 2005/0259420 A1
(43) Pub. Date: Nov. 24, 2005

(54) Storage container lighting system

(76) Inventor: Steven D. Petersen, Chandler, AZ (US)

Correspondence Address: Steven D. Petersen, 1527 W. Boise Place, Chandler, AZ, 85224, US

(21) Appl. No.: 11/127,661

(22) Filed: May 10, 2005

Related U.S. Application Data
(60) Provisional application No. 60/573,179, filed on May 21, 2004.

(51) Int. Cl. F21V 33/00

(52) U.S. Cl. 362/253

(57) ABSTRACT

A Storage Container Lighting System 10 that is a battery-powered light with automatic ON and OFF function activated by raising or lowering a storage container cover 30 or other surface to which it is attached. Angle of activation is adjustable. System 10 has portability capability. System 10 provides light through use of low current, high-intensity white light emitting diodes 22. System 10 allows for different colored lamps for specialized applications. Tilt-activated switch 26 activates light when storage container cover 30 is raised and turns off light when cover 30 is lowered. Rocker switch 24 is provided so lights can be turned off when cover 30 is left open for extended period of time. Standard household batteries 42 serve as a power supply. Module 14, a low profile enclosure, houses electronic components. Module 14 slides into base 12. Base 12 is mounted to a container cover or other surface using either double-sided foam tape 20 or optional screws through mounting holes 18. Thumb screws 16 allow removal of module 14 from base 12 for use as a light source in another location.

### CROSS-REFERENCE TO RELATED APPLICATION

This application claims the benefit of Provisional Patent Application Ser. No. 60/573,179 filed 2004, May 21.

### BACKGROUND

1. Field of the Invention

The present invention relates to portable lighting systems for coverable storage containers.

### COPYRIGHT NOTICE

A portion of the disclosure of this patent document contains material that is subject to copyright protection. The copyright owners have no objection to the facsimile reproduction by anyone of the patent document or the patent disclosure as it appears in the U.S. Patent and Trademark Office patent file or records, but otherwise reserves all copyrights whatsoever.

### BACKGROUND

2. Description of Prior Art

A pickup truck or other vehicle can be equipped with covered storage containers permanently attached or placed in the vehicle. The storage container can hold a variety of items such as power and hand tools, and supplies. At night, or in a dark location, retrieving items from such containers becomes difficult due to lack of light. Any light provided by a vehicle manufacturer inside the cab of a vehicle or from the top of a vehicle to illuminate an area of a vehicle, such as a truck bed, is blocked by raising the storage container cover. This lack of light is dangerous due to sharp blades and pieces commonly associated with power and hand tools.

In hazardous situations, such as a flat tire at night, a convenient source of light in the problem area is not provided by vehicle manufacturers. When a conventional flashlight is used, one hand is needed to hold it, reducing the ability of a user to locate and move or retrieve items from within a storage container, or to aim a light where it is needed in the case of a mechanical failure.

Similarly, some trucks are equipped with a tonneau cover over an entire truck bed creating a large storage area. When items are stored in the bed of a pickup truck with a tonneau cover and the tonneau cover is raised, any light provided by the vehicle manufacturer to illuminate the truck bed is blocked by the raised tonneau cover.

Certain automobile trunks lack lighting to illuminate the inside of the trunk restricting the safe and efficient addition, retrieval, or movement of items contained in such trunks.

Construction job site containers with covers are large, secure enclosures used for storage of such items as tools, supplies, and equipment needed at a work site. Such items must be put away in a manner which allows the container to be closed and locked. Often, power is unavailable where the container is located, so when light is needed conventional lights cannot be used. Handheld lights restrict the handling of items to be stored.

The following is a description and the disadvantages of these various known methods of providing light in storage containers:

U.S. Pat. No. 6,227,677 to Willis 2001 May 8, discloses a portable light. The light in Willis U.S. Pat. No. 6,227,677 is not well suited for storage containers, such as a toolbox, for several reasons. The light disclosed is not equipped with a tilt-sensitive switch; therefore, automatic operation is not possible. The light uses a cold cathode fluorescent lamp that does not lend itself to the rugged environment associated with a work truck or storage container. The light does not provide convenient mounting methods that would allow removal of the light for emergency use.

U.S. Pat. No. 5,347,440 to Roberts, et al 1994 Sep. 13, discloses a portable light. The light in Roberts, et al U.S. Pat. No. 5,347,440 is not well suited for storage containers, such as a toolbox, for several reasons. The light disclosed in Roberts, et al U.S. Pat. No. 5,347,440 is not equipped with a tilt-sensitive switch; therefore, automatic operation is not possible. The removal of the lamp unit from the body of the light disclosed in Roberts, et al U.S. Pat. No. 5,347,440 prohibits electrical power from reaching the lamp and thus cannot be used in a location where the lamp body is not available. Incandescent bulbs utilized in this device are inefficient, compared to Light Emitting Diode (LED) lamps, resulting in a device with a short battery life. Incandescent bulbs are sensitive to vibration and breakage, so do not lend themselves to the rugged environment associated with a work truck or storage container.

### DISADVANTAGES OF PRIOR ART

Thus, heretofore known methods and devices for covered storage container lighting suffer from a number of disadvantages as set forth along with reasons the present invention is superior:
(a) some existing storage container lighting systems require incandescent light bulbs that are sensitive to vibration, are relatively inefficient, are not portable, and have relatively short operating lives; the present invention does not require incandescent light bulbs;
(b) Some existing storage container lighting systems require wiring the lighting system into the electrical system of a vehicle to provide power; the present invention does not require power from the electrical system of a vehicle;
(c) some existing storage container lighting systems do not allow optional methods for the use of screws to mount a lighting system to a surface; the present invention offers optional methods of mounting;
(d) some existing storage container lighting systems require an independent power source that requires time consuming and difficult installation due to the requirement for drilling holes in the storage container to accommodate electrical wiring; the present invention does not require holes be drilled in a storage container for power source;
(e) some existing storage container lighting systems allow the light to be left on, unintentionally resulting in draining of the batteries providing the power because the power is controlled by a manual switch; the present invention is controlled by a tilt switch that does not allow the light to be left on unintentionally;
(f) some existing storage container lighting systems rely solely on a tilt-activated switch to turn the light on or off; the present invention, in addition to its tilt-activated light, provides a manual switch to turn the light off when a storage container cover is left open for an extended period of time;
(g) some existing storage container lighting systems require reflectors inside an enclosure to direct light emission, resulting in an assembly that is large, high profile, and expensive; the present invention does not require reflectors;
(h) some existing storage container lighting systems provide only a fixed angle of activation; the present invention has an adjustable angle of activation;
(i) some existing storage container lighting systems are permanently mounted to one surface which precludes removing the light for use in other locations; the present invention allows for easy removal of the light for use in another location;
(j) some existing storage container lighting systems utilize a photo-sensitive switch to turn the light off when ambient environmental light reaches a predetermined level, which presents a problem at certain times of the day, such as daybreak or dusk, and when other light sources, such as vehicle headlights, turn the light off at inopportune times; the present invention allows manual operation of the light and is not affected by changing ambient light conditions; and
(k) some existing storage container lighting systems are restricted to white light; the present invention allows use of colored LED lamps.

Prior art does not provide a system with a tilt-sensitive ON OFF switch along with a manual switch to conserve battery life. Prior art does not provide bright white LED lamps that are durable and are not sensitive to vibration. Prior art does not provide for removal of lighting device from a mounting location for use outside a storage container. Prior art does not allow for use of colored lamps for use in specialized situations, such as a red lamp for use in an emergency situation.

### SUMMARY OF THE INVENTION

In accordance with the present invention a Storage Container Lighting System comprises a module that houses electronic components, including an automatic ON and OFF function activated by raising or lowering of a surface to which Lighting System is attached, and a base to house module, such system which in its preferred embodiment consists of:
(1) a battery-powered light with portability capability;
(2) one or more Light Emitting Diode lamps to provide low current, high intensity light;
(3) standard household batteries to serve as power supply;
(4) an internal tilt-sensitive switch to activate the light when toolbox, tonneau, or other container covers are raised, and turns light off when cover is lowered;
(5) a manual switch, including a rocker switch or a toggle switch, to allow light to be turned off when cover is left open for extended periods of time;
(6) a battery holder to accommodate standard household batteries;
(7) a formed module to house electronic components;
(8) a formed base to accommodate the module;
(9) two thumb screws to hold formed module to formed base, to allow module to be removed from storage container cover for use in another location;
(10) double-sided foam tape to mount base to a storage container cover; and
(11) screws to mount base to a storage container cover, when tape will not stick to certain surfaces, including fiberglass and fabric-covered surfaces of tonneau covers.

### OBJECTS AND ADVANTAGES

Accordingly, besides the objects and advantages of the Storage Container Lighting System with portability capability previously described, several objects and advantages of the present invention are:
(a) to provide coverable storage containers with a lighting system, using bright white Light Emitting Diode (LED) lamps resulting in intense light, without the use of inefficient incandescent bulbs that are sensitive to vibration;
(b) to provide coverable storage containers with a lighting system powered by common household batteries instead of requiring use of an electrical system, such as the electrical system of a vehicle, to provide power;
(c) to provide coverable storage containers with a lighting system that allows optional methods of mounting the lighting system, including the use of screws to mount the lighting system to a container surface where use of double-sided tape is not viable, instead of requiring drilling of holes for screws as an only installation option; P1 (d) to provide coverable storage containers with a lighting system utilizing a self-contained battery-powered light that is easy to install without drilling holes to accommodate wire for power, instead of a lighting system that uses an electric light requiring an independent power source which requires holes be drilled through container to accommodate wires for electrical power which results in a more time consuming and difficult installation;
(e) to provide coverable storage containers with a lighting system controlled by a tilt-activated switch that allows a light to come on when a storage cover is opened and go off when a storage cover is closed, so the light cannot be left on unintentionally and drain batteries, instead of a system using a manual switch exclusively that can be left on unintentionally and result in draining of batteries;
(f) to provide coverable storage containers with a lighting system with a manual switch to allow the light to be turned off when a storage container cover is left open for an extended period of time, instead of a system that relies completely on a tilt-activated switch to turn light on or off;
(g) to provide coverable storage containers with a lighting system that use bright white Light-Emitting Diode (LED) lamps to provide intense light without the requirement of reflectors, instead of a light source that requires reflectors to direct light emission and that results in an assembly that is large, high profile, and expensive;
(h) to provide coverable storage containers with a lighting system with an adjustable angle of activation, instead of a system that provides only a fixed angle of activation;
(i) to provide coverable storage containers with a lighting system that allows for easy removal of the light for use in another location, instead of a lighting system permanently mounted to one surface that does not allow the light to be used in other locations;
(j) to provide coverable storage containers with a lighting system that can be switched off by a manual power switch when light is not needed and that is not affected by changing ambient light conditions, instead of utilizing a photo-sensitive switch that turns the light off at inopportune times; and
(k) to provide coverable storage containers that allow use of colored LED lamps, instead of lighting systems restricted to white light.

The principal object of the Storage Container Lighting System, for toolboxes and tonneau covers for pickup trucks and other vehicles, construction job site boxes, and other coverable storage containers, is to provide: (1) easy to install, (2) durable, (3) low maintenance, (4) adjustable, (5) portable, and (6) simple to manufacture, so that when the cover of a container is raised the Storage Container Lighting System automatically turns on and when the cover of a container is lowered the Storage Container Lighting System automatically turns off; by the methods herein described.

### FURTHER OBJECTS AND ADVANTAGES

Further objects and advantages of the Storage Container Lighting System are: (1) to provide a system that uses of LED lamps that can be replaced with dual color LED lamps, and (2) that uses a rocker switch that can be replaced with an ON-OFF-ON type manual switch. In these embodiments, the Lighting System acts as either a lighting system for a storage container or as an emergency light in a hazardous situation, such as for a stalled vehicle:
when the rocker switch is in ON position and a container cover is raised, the LED lamps produce white light for lighting a storage container;
when the rocker switch is in the OFF position, no light is produced, regardless of the container cover position; and
when the rocker switch is in the secondary ON position and the container cover is raised, another color such as blue or yellow light is produced by the LED lamps.

Alternative embodiments, providing further objects and advantages of the Storage Container Lighting System, are: (1) alternative mounting methods; (2) alternative materials; (3) use of three or more LED lamps; (4) use of lamps of varying intensities; (5) option to use varying types of light sources, other than LED lamps; (6) use of multi-colored lights as an emergency marker for a stalled vehicle; and, (7) the use of a flashing function.

The Storage Container Lighting System is portable and can be removed from its normal place in a vehicle storage container or tonneau cover, and aimed at oncoming traffic with red or yellow lights on or flashing, to provide a warning that the vehicle is stalled.

Further, more than one Storage Container Lighting System with portability can be used for additional lighting.

Still further objects and advantages will become apparent from a consideration of the ensuing description and drawings.

### BRIEF DESCRIPTION OF DRAWING FIGURES

FIG. 1 is a perspective view showing Storage Container Lighting System module and base.

FIG. 2 is a perspective view showing Storage Container Lighting System module.

FIG. 3a is a side view of Storage Container Lighting System showing mounting surface in resting position.

FIG. 3b is a side view of Storage Container Lighting System showing mounting surface in raised position with lighting system emitting light.

FIG. 4 is a perspective view showing a typical mounting location for Storage Container Lighting System.

FIG. 5 is an exploded view of Storage Container Lighting System and its components.

### REFERENCE NUMERALS IN DRAWINGS

| | |
|---|---|
| 10 | Storage Container Lighting System |
| 12 | formed base |
| 14 | formed module |
| 16 | thumb screw |
| 18 | mounting hole |
| 20 | double-sided foam tape |
| 22 | Light Emitting Diode (LED) lamp |
| 24 | rocker switch |
| 26 | tilt-activated switch |
| 28 | storage container |
| 30 | storage container cover |
| 32 | resistor |
| 34 | battery holder |
| 36 | positive polarity red wire |
| 38 | insulated wire |
| 40 | negative polarity black wire |
| 42 | batteries |
| 44 | module thumb screw hole |
| 46 | threaded base thumb screw hole |

### DETAILED DESCRIPTION OF THE INVENTION

It is an object of the Storage Container Lighting System to provide one or more of the following desirable features not heretofore known or used.

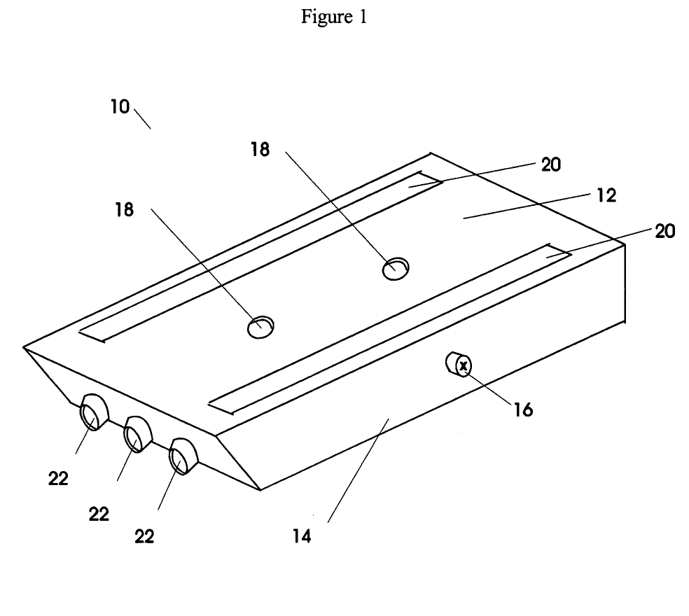

### Description—FIG. 1—Preferred Embodiment

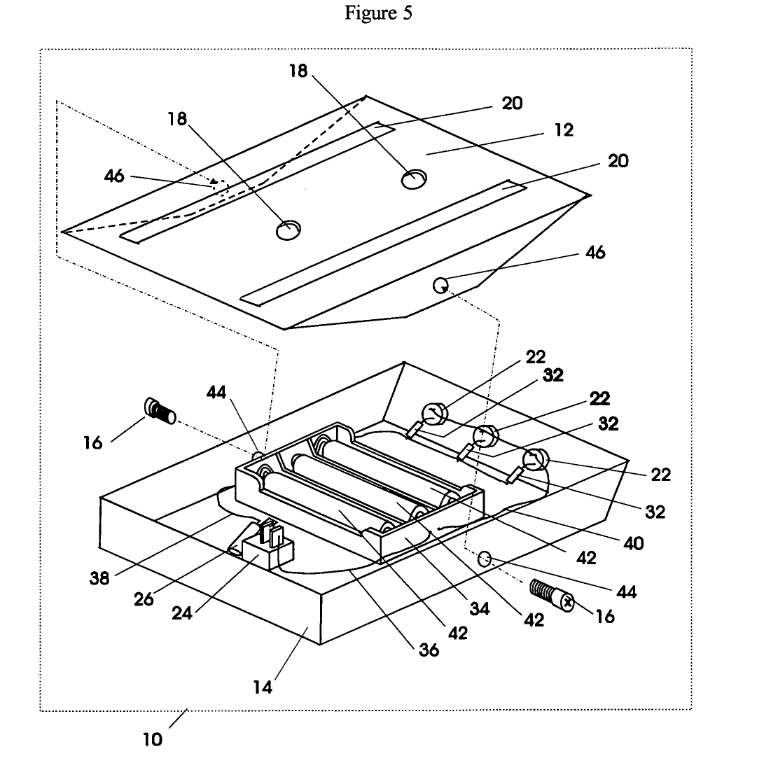

FIG. 1 is perspective view showing formed base 12 of Storage Container Lighting System 10. Thumb screw 16 located on side near the center of Lighting System 10 secures formed module 14 to base 12. A second thumb screw 16 is located in a similar location on the opposite side of module 14. (See FIG. 5)

One option for attaching base 12 to a container cover or other fixed location is to use double-sided foam tape 20 on surface of base 12 to adhere Lighting System 10 to fixed location. Another option for attaching base 12 to a container cover or other fixed location is to bore mounting holes 18 into surface of base 12 for use in attaching base 12 with screws to a fixed location. Three Light Emitting Diode (LED) lamps 22 on one end of module 14 are automatically activated when Lighting System 10 is tilted to a pre-determined angle.

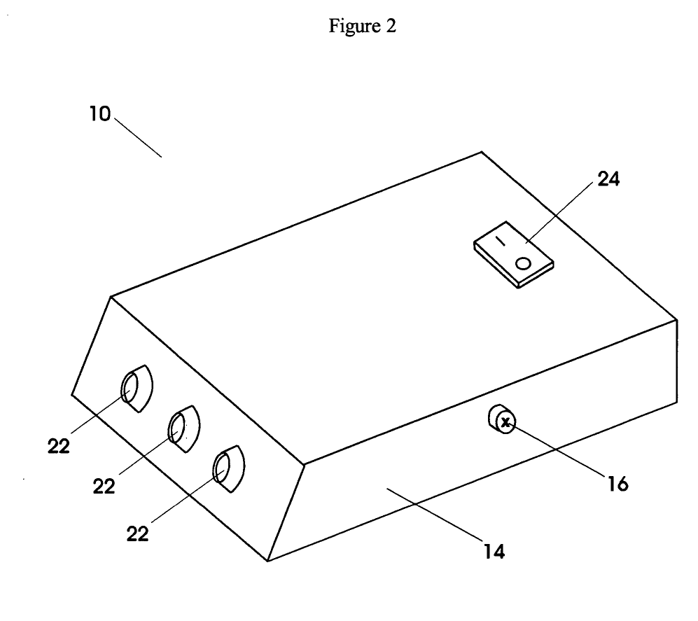

### Description—FIG. 2—Preferred Embodiment

FIG. 2 is perspective view of formed module 14 portion of Storage Container Lighting System 10. Rocker switch 24 is mounted to module 14 near the opposite end from LED lamps 22. Thumb screw 16 on either side of module 14 allows module 14 to be removed from mounted position. (See FIG. 5)

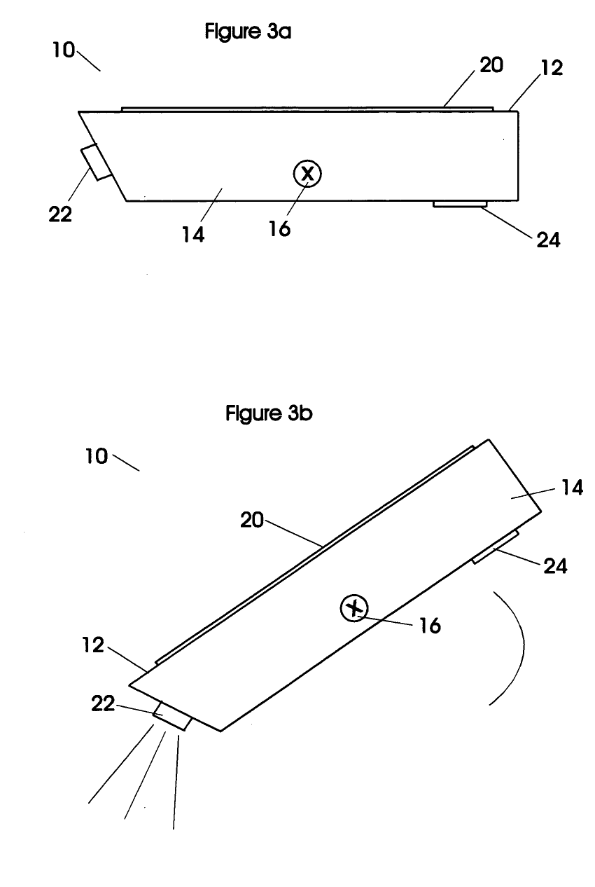

### Description—FIGS. 3a and 3b—Preferred Embodiment

FIG. 3a is a side view of Storage Container Lighting System 10 showing mounting surface in resting or horizontal position, as it would be with host container cover closed. Double-sided foam tape 20 on formed base 12 adheres Lighting System 10 to a mounting surface. In resting or horizontal position, LED lamps 22 are off when rocker switch 24 is in the ON or OFF condition. Thumb screw 16 on either side of Lighting System 10 (See FIG. 5) can be removed to allow formed module 14 to be separated from base 12 and moved to another location.

FIG. 3b is side view of Storage Container Lighting System showing Lighting System 10 in raised or tilted position with Lighting System 10 emitting light, as it would be with host container cover open. When rocker switch 24 is in ON condition, LED lamps 22 are on. When rocker switch 24 is in OFF condition, LED lamps 22 are off. Thumb screw 16 can be removed to allow formed module 14 to be separated from base 12. Double-sided foam tape 20 holds base 12 to a mounting surface when module 14 is removed from base 12. When mounting surface is lowered, or closed, and Lighting System 10 is returned to resting or horizontal position, LED lamps 22 are automatically deactivated to an OFF condition regardless of condition of rocker switch 24.

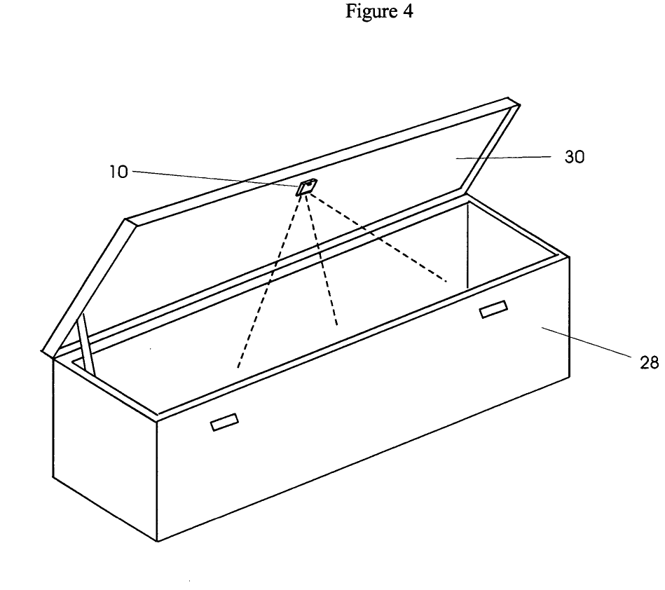

### Description—FIG. 4—Preferred Embodiment

FIG. 4 is perspective view of a storage container 28 showing Storage Container Lighting System 10 in a typical mounting location when mounting surface is a storage container cover 30.

### Description—FIG. 5—Preferred Embodiment

FIG. 5 is exploded view of Storage Container Lighting System 10 and its components. Lighting System 10 consists of formed module 14 and formed base 12. Shape of module 14 is formed using predetermined specifications.

LED lamps 22 mount to module 14 at one end of module 14. Resistors 32 are soldered to LED lamps 22. Rocker switch 24 is mounted to module 14 at end opposite LED lamps 22. Tilt-activated switch 26 mounts on side of rocker switch 24. Switch 26 is placed at predetermined angle and is electrically connected in series with rocker switch 24. Insulated wire 38 is electrically connected from switch 26 to resistors 32.

Battery holder 34 mounts on inside surface near the center of module 14 when module is made of metal. In a plastic version of module 14, battery holder is molded part of housing. Battery holder 34 has a positive polarity red wire 36 and a negative polarity black wire 40. Red wire 36 is electrically connected to rocker switch 24. Black wire 40 is electrically connected to LED lamps 22.

Lighting System 10 is tested by inserting batteries 42 into battery holder 34, moving rocker switch 24 to ON position, and rotating Lighting System 10, as shown in FIG. 3b, until LED lamps 22 turn ON. When operating properly light should be provided by LED lamps 22 when Lighting System 10 is rotated to approximately a thirty-degree angle from horizontal and remain in ON condition until Lighting System 10 reaches a predetermined vertical stopping point. When rocker switch 24 is turned to OFF position, LED lamps 22 go OFF, regardless of position of Lighting System 10.

Turning rocker switch 24 back to ON position turns on LED lamps 22. Lighting System 10 is rotated back toward horizontal direction, and when operating properly, LED lamps 22 go OFF after Lighting System 10 reaches an angle of less than approximately thirty degrees from horizontal. When Lighting System 10 is back in a horizontal position, as shown in FIG. 3a, LED lamps 22 remain OFF regardless of position of rocker switch 24.

Final assembly of Lighting System 10 is accomplished by sliding module 14 over base 12, aligning module thumb screw hole 44 with threaded base thumb screw hole 46 and inserting thumb screw 16 on each side to hold module 14 and base 12 together.

Mounting holes 18 are for use when screws are used as an installation option. Double-sided foam tape 20 is on base 12 for installation without screws.

### Conclusion, Ramifications, and Scope

Accordingly, the reader will see that the Storage Container Lighting System can be used to light a storage container utilizing a module that houses electronic components, including an automatic ON and OFF function activated by raising or lowering of a surface to which Lighting System is attached, and a base to house an impact resistant module.

The Lighting System of this invention utilizes bright white Light Emitting Diode lamps that are battery-powered and activated through use of an internal tilt-sensitive switch to activate the light when container covers are raised, and turn light off when cover is lowered. Double-sided foam tape is utilized for easy installation of base to storage container cover, when mounting surface can accommodate tape; screws can be used when tape will not stick to certain surfaces, including fiberglass and fabric-covered surfaces. A manual switch allows light to be turned off when container cover is left open for an extended period of time to conserve battery life. Thumb screws hold module to base to allow easy removal from base so light can be used in a location separate from a container.

Although the description above contains many specificities, these should not be construed as limiting the scope of the invention but as merely providing illustrations of some of the presently preferred embodiments of this invention. For example, the formed module and formed base of the Storage Container Lighting System can be made with various types of plastics, metals, and other materials. The size of the Lighting System can vary in size. Additional LED lamps can be added to Lighting System. Functioning light sources other than LEDs may be used. System can be placed in fixed position and turned on by use of the ON OFF switch. System can be attached to surfaces using various forms of attachment including magnets. System can be easily modified to be a portable light for use as a flashlight.

Thus the scope of the invention should be determined by the appended claims and their legal equivalents, rather than by the examples given.

1. A self-contained storage container lighting system with portability comprising:
one or more Light Emitting Diodes (LEDs), or similar functioning light sources;
an internal tilt-sensitive switch;
a manual power switch including a rocker or a toggle switch;
a battery holder;
wiring;
an enclosure incorporating a low profile design; and
a power source.

2. The system of claim 1, wherein:
activation of said system is dependent upon turning said manual power switch to ON position;
activation of LEDs occur when said system is tilted above a predetermined angle;
deactivation of LEDs occur when said system is returned below a predetermined angle;
angle of LED activation is adjustable; and
system can be turned off while cover is in raised position.

3. The system of claim 1, wherein wiring to the electrical system of an external power source is not required.

4. The system of claim 1, wherein LEDs can be different colors.
